(19) United States
(12) Patent Application Publication
(10) Pub. No.: US 2004/0148416 A1
(43) Pub. Date: Jul. 29, 2004

(54) Method and apparatus for messaging between a client of an sip-based network and a client of a wireless village network

(76) Inventors: Jryki Aarnos, Kangasala (FI); Juha Kalliokulju, Vesilahti (FI); Jose Costa-Requena, Helsinki (FI); Hisham Khartabil, Helsinki (FI); Ilkka Westman, Helsinki (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(21) Appl. No.: 10/353,847

(22) Filed: Jan. 29, 2003

(51) Int. Cl. G06F 15/16

(52) U.S. Cl. 709/230

(57) ABSTRACT

A method (and corresponding equipment) by which a first device (11a), operable in a first network (11) including an SIP type of network (such as an IMS network) to which the first device (11a) is subscribed, communicates with a second device (12a), operable in a second network (12) including a WV network to which the second device (12a) is subscribed, the method providing routing steps so that each SIP network entity, such as an I-CSCF (11f), that processes the message encounters an SIP addressing scheme, i.e. the addressing scheme native to the SIP type of network, and so that each WV server (12b) encounters only an addressing scheme native to the WV network, after possibly preliminary conversion (A0-D0) to the native addressing scheme. The first network (11) may also include components of a WV network, and the second network (12) may also include components of an SIP type of network.

### CROSS REFERENCE To RELATED APPLICATIONS

Reference is made to co-owned U.S. application Ser. No. 10/265,650 filed on Oct. 3, 2002, and entitled WV-IMS RELAY AND INTEROPERABILITY METHODS.

Reference is also made to co-owned U.S. application Ser. No. 10/336,643, filed Jan. 3, 2003, and entitled METHOD AND APPARATUS FOR ROUTING WIRELESS VILLAGE MESSAGES IN AN INTERNET PROTOCOL MULTIMEDIA SUBSYSTEM.

The above-referenced applications are assigned to the present assignee. The subject matter of the above applications is hereby incorporated by reference.

### TECHNICAL FIELD

The present invention relates to interoperability between end-user devices for use in similar but different kinds of telecommunication systems, different in respect to the protocols used between the servers and between the servers and the devices. More particularly, the present invention relates to messaging between a subscriber to (client of) an IMS (Internet Protocol Multimedia Subsystem) telecommunication system/network or other SIP (Session Initiation Protocol) or equivalent protocol based network, in a first telecommunication network provided by a first network operator, and a subscriber to (client of) a WV (Wireless Village) telecommunication system/network in a second telecommunication network provided by a second network operator.

### BACKGROUND ART

The present invention provides for routing messages between an end user device subscribed to a first telecommunication system, namely a telecommunication system including an IMS (Internet Protocol Multimedia Subsystem) or other SIP (Session Initiation Protocol) based network, that primarily uses a single protocol throughout, namely SIP, and a second telecommunication system, namely a WV (Wireless Village) or related telecommunication system, that primarily uses different protocols between its servers and between its servers and its devices, and in particular in the case that the two telecommunication systems are provided by different network operators.

IMS is specified by the so-called third generation partnership project (3GPP), and WV is specified by the Mobile Instant Messaging and Presence Services (IMPS) Initiative formed in April 2001 as part of the Wireless Village Initiative to define and promote a set of universal specifications for mobile instant messaging and presence services. The WV specification work, originally provided by the Wireless Village Initiative, continues today under the auspices of OMA, which plans to soon publish WV 1.2 specifications. (The Wireless Village Initiative joined several other industry groups to form the Open Mobile Alliance (OMA) for creating a single source for mobile Web service applications. The OMA is an extension of the open mobile architecture initiative, and is the result of a consolidation of the Open Mobile Architecture initiative and the WAP (wireless-application protocol) Forum. Also merged with the forum are the Location Interoperability Forum (LIF), the MMS Interoperability Group (MMS-IOP) and the SyncML Initiative. The consortium pools resources from all of the older wireless groups to create universal mobile application programming interfaces (APIs) on the Java framework.)

FIG. 5 shows two networks, a network A 11 and a network B 12 provided (usually, but not necessarily) by different network operators; network A 11 is indicated by a domain name of “domain A,” and network B is indicated by a domain name of “domain B.” Network A 11 includes a radio access network and core network elements (none of which are shown) connecting an (end-user device) IMS client 11a to a proxy call state control function entity (P-CSCF) 11b of an IMS, the IMS also including a serving CSCF (S-CSCF) 11c and an interrogating CSCF (I-CSCF) 11f.

To understand routing according to the prior art, consider as an example the routing of a message from the IMS client 11a to an IMS client (not shown) subscribed to network B (or to any SIP client, not necessarily an IMS client, subscribed to network B) and having a URI of e.g. other-ims-user@domain-b.com. A message from the IMS client 11a (via the P-CSCF 11b) arriving at S-CSCF (or any SIP proxy in any other SIP-based network with similar functionality to the S-CSCF in IMS networks) 11c is assumed here to have a uniform resource identifier (URI) of the form:

scheme:<username>@<domain>

where scheme is e.g. “sip:” or “wv:” and indicates the type of telecommunication system to which the target is a subscriber; the form assumed here for a URI is intentionally simplified from the general form in order to more easily explain the invention. Upon receiving such a message from the IMS client 11a (via the proxy P-CSCF 11b), S-CSCF 11c queries a DNS (domain name system) server 11g (or some other database providing location services) to obtain a domain name (e.g. “i-cscf.domain-b.com”) and then an IP address for the next hop server in the target domain to send the (SIP) message to (which in this case would be the target-side I-CSCF 12d or any SIP proxy that acts as the entry point to the destination SIP based network); a DNS server is an element of a distributed database, and given a domain name, a DNS server will provide an IP address or information useful in determining such an address. (As an example, if the message has a URI for an end-user device (not shown) having a URI of other-ims-user@domain-b.com, the S-CSCF 11c may e.g. provide to the DNS server 11g (or other database providing equivalent location services) the domain name, “i-cscf.domain-b.com,” and the DNS server might then provide an IP address for the target-side I-CSCF 12d.) Since the message is for a device in the other IMS network (in network B, i.e. for the end-user device having a URI of e.g. other-ims-user@domain-b.com), with an IP address of a next hop server in hand, the S-CSCF 11c then provides the message to the I-CSCF 12d. The I-CSCF 12d then interrogates an HSS (home subscriber server) 12f (or any similar location service implemented as a directory or databases mechanism, such as e.g. LDAP or Whois+) for the local domain to determine the next hop based on the IP address for the domain name; the HSS 12f provides location management services, user data handling services, and user authentication services, and, in particular, will respond to a query from the I-CSCF 12d indicating a particular subscriber with any information the HSS has as to the location of the subscriber (information it has because the subscriber registers with the HSS via one or another S-CSCF entity). Both the DNS server 12e and the HSS server 12f are part of the IMS provided as part of network B, and there are corresponding entities included in the IMS provided as part of network A.

Network A 11 is also shown as including a WV/IMS gateway 11d for connecting the IMS elements of domain A to WV elements of either domain A (if any) or domain B. Finally, network A is also shown as sometimes including a WV server 11e.

Network B 12 includes a radio access network and core network elements (none of which are shown) connecting an (end-user device) WV client 12a to a (home) WV server 12b. (A WV server includes its own directories for routing messages to WV clients.) Network B 12 also sometimes includes some elements of an IMS, namely an I-CSCF 12d, an HSS 12f and a DNS server 12e. Finally, the network operator for network B 12 is assumed here to provide a WV/IMS gateway 12c for connecting the IMS elements of domain B to WV elements of either domain A (if any) or domain B.

According to the WV “System Architecture Model version 1.1,” a WV system is a client-server based system where the server is an IMPS (Instant Messaging and Presence) server and the clients can be either mobile terminals or other services or applications for fixed PC clients. The WV server 12b and WV client 12a communicate according to either client-server protocol (CSP) or command line protocol (CLP). For interoperability, the WV servers (and gateways) from different domains are connected by a server-to-server protocol (SSP) defined in various WV specifications now published at version 1.1, which may be found at www.wireless-village.org (which now redirects to: openmobilealliance.org/wirelessvillage/). If a WV server receives a message addressed to a user within the same domain as the WV server, the WV will send the message to the user using CSP or CLP instead of SSP.

In setting up a communication path, the IMS entities 11a 11b communicate using a single protocol, namely SIP (Session Initiation Protocol), standardized by the IETF (Internet Engineering Task Force).

Because of the use of different protocols by WV systems and IMS systems, providing communication between clients of the two different systems is problematic. To compound the problem, there may be some operators who deploy the IMS but not the WV, and other operators who deploy the WV but not the IMS but nonetheless wish to offer their customers access to the other service.

Co-owned U.S. application Ser. No. 10/265,650 filed on Oct. 3, 2002, and entitled WV-IMS RELAY AND INTEROPERABILITY METHODS adds mapping functionality (i.e. protocol translation services) to an Application Server (AS) of a 3GPP IMS (or to an IMS/WV gateway either coupled to the AS so as to be part of the AS or existing as a standalone server or bundled with a WV server), mapping functionality that provides for translating addresses between a WV server of a WV system and the AS to permit interoperability between WV clients and IMS clients and so to allow, optionally, for instant messaging and presence services for operators who have deployed both IMS and WV or only one of the WV and IMS systems.

Co-owned U.S. application Ser. No. 10/336,643 filed on Jan. 3, 2003, a continuation-in-part of Ser. No. 10/265,650 and entitled METHOD AND APPARATUS FOR ROUTING WIRELESS VILLAGE MESSAGES IN AN INTERNET PROTOCOL MULTIMEDIA SUBSYSTEM, provides for communication between an IMS client, such as the IMS client 11a of network A (FIG. 5), and a WV client, such as the WV client 12a of network B 12, by providing a new user URI parameter and functionality to examine a message from an IMS client for use of the new URI parameter to determine if the message is intended for a WV client despite the address of the (SIP) message having a scheme of “sip:,” which would ordinarily indicate that the target (intended recipient) is an IMS client.

What would be advantageous to have as an alternative to what is provided by the prior art is an even simpler way for an IMS client (or a client of any SIP type of network) to communicate with a WV client, a way that does not require use of a new user parameter, but instead uses ordinary SIP (or equivalent) messages (i.e. not including any kind of user URI parameter to indicate a scheme other than “sip:” and using only “sip:” as the schema) and uses correspondingly ordinary WV messages in WV (i.e. using only “wv:” as the schema in any message according to any of the various protocols used in WV).

### DISCLOSURE OF THE INVENTION

Accordingly, in a first aspect of the invention, a method is provided by which a first device, operable in a first network including an SIP type of network to which the first device is subscribed, communicates with a second device, operable in a second network including a wireless village (WV) network to which the second device is subscribed, the SIP type of network having a serving call state control function (S-CSCF) entity for communicating with the first device via a proxy CSCF (P-CSCF) entity using a first protocol requiring that a message have a request uniform resource identifier (URI) including an address scheme according to the first protocol, the WV network having a WV server for communicating with other WV servers using a second protocol and with the second device using a third protocol possibly different from the second protocol, the method characterized in case of a message originating with the first device and intended for the second device by: a step in which the S-CSCF of the first network routes the message to either a gateway in the first network upon a determination that the second network does not include an SIP type of network, or to an interrogating CSCF (I-CSCF) of an SIP type of network in the second network which then in a subsequent step routes the message to a gateway in the second network upon a determination by the I-CSCF of the second network that the URI does not correspond to a subscriber to the SIP type of network in the second network; and further characterized in the case of a message originating with the second device and intended for the first device by: a step in which the WV server of the second network routes the message either to a gateway in the second network or to a gateway in the first network or to a WV server in the first network.

In accord with the first aspect of the invention, the method may be further characterized, in case of a message originating with the first device and intended for the second device by: a step in which if the message is entered into the device operable in the first network with a URI having an address scheme according to other than the first protocol, before the S-CSCF of the first network performs a domain name space (DNS) query for routing the message, the URI of the message is converted by either the first device or the P-CSCF or the S-CSCF to use the address scheme according to the first protocol.

Also in accord with the first aspect of the invention, the method may be further characterized in the case of a message originating with the second device and intended for the first device by: a step in which if the message is entered into the second device with a URI having an address scheme according to other than the second protocol (SSP), either the second device or the WV server converts the URI to use the address scheme according to the second protocol.

Still also in accord with the first aspect of the invention, the P-CSCF and S-CSCF of the first network may be elements of an Internet Protocol Multimedia Subsystem (IMS).

Still also in accord with the first aspect of the invention, the I-CSCF of the second network is an element of an Internet Protocol Multimedia Subsystem (IMS).

Still also in accord with the first aspect of the invention, the method may be further characterized in case of the message originating with the first device by: a step in which either the gateway in the first network or the gateway in the second network converts the URI so as to use the address scheme according to the second protocol and also translates the message so as to be in accord with the second protocol.

Still also in accord with the first aspect of the invention, the method may be further characterized in case of the message originating with the second device by: a step in which either the gateway in the second network or the gateway in the first network converts the URI so as to use a scheme according to the first protocol and also translates the message so as to be in accord with the first protocol.

In a second aspect of the invention, an apparatus is provided comprising means for performing the steps of the method according to the first aspect of the invention indicated as the steps performed by the first device.

In a third aspect of the invention, an apparatus is provided comprising means for performing the steps of the method according to the first aspect of the invention indicated as the steps performed by the second device.

In a fourth aspect of the invention, a system is provided comprising means for performing the steps of the method according to the first aspect of the invention indicated as the steps performed by the P-CSCF, the S-CSCF and the gateway of the first network.

In a fifth aspect of the invention, a system is provided comprising means for performing the steps of the method according to the first aspect of the invention indicated as the steps performed by the P-CSCF, the S-CSCF of the first network, and the WV server of the first network.

In a sixth aspect of the invention, a system is provided comprising means for performing the steps of the method according to the first aspect of the invention indicated as the steps performed by the WV server and the gateway of the second network.

In a seventh aspect of the invention, a system is provided comprising means for performing the steps of the method according to the first aspect of the invention indicated as the steps performed by the WV server and the gateway of the second network and indicated as the step of receiving the message performed by the I-CSCF of the second network.

In an eighth aspect of the invention, a storage medium holding a set of instructions for execution by a processor included in an apparatus is provided, the set of instructions comprising instructions for performing the steps of the method according to the first aspect of the invention indicated as the steps performed by the first device.

In a ninth aspect of the invention, a storage medium holding a set of instructions for execution by a processor included in an apparatus is provided, the set of instructions comprising instructions for performing the steps of the first aspect of the invention indicated as the steps performed by the second device.

In a tenth aspect of the invention, one or more storage media holding sets of instructions for execution by processors included in equipment of a communication network is provided, the sets of instructions comprising instructions for performing the steps of the method according to the first aspect of the invention indicated as the steps performed by the P-CSCF, the S-CSCF and the gateway of the first network.

In an eleventh aspect of the invention, one or more storage media holding sets of instructions for execution by processors included in equipment of a communication network is provided, the sets of instructions comprising instructions for performing the steps the method according to the first aspect of the invention indicated as the steps performed by the P-CSCF and the S-CSCF of the first network and also the step of receiving the message performed by the WV server of the first network.

In a twelfth aspect of the invention, one or more storage media storing sets of instructions for execution by processors included in equipment of a communication network is provided, the sets of instructions comprising instructions for performing the steps of the method according to the first aspect of the invention indicated as the steps performed by the WV server and the gateway of the second network.

In a thirteenth aspect of the invention, one or more storage media storing sets of instructions for execution by processors included in equipment of a communication network is provided, the sets of instructions comprising instructions for performing the steps of the method according to the first aspect of the invention indicated as the steps performed by the WV server and the gateway of the second network, and also the step of receiving the message performed by the I-CSCF of the second network.

### BRIEF DESCRIPTION OF THE DRAWINGS

The above and other objects, features and advantages of the invention will become apparent from a consideration of the subsequent detailed description presented in connection with accompanying drawings, in which:

FIG. 1 is a message sequence diagram showing routing according to the invention for a message originating from an IMS client in a first operator network and bound for a WV client in a second operator network, in the case the second operator network includes an IMS network;

FIG. 2 is a message sequence diagram showing routing according to the invention for a message originating from an IMS client in a first operator network and bound for a WV client in a second operator network, in the case the second operator network does not include an IMS network;

FIG. 3 is a message sequence diagram showing routing according to the invention for a message originating from a WV client in a first operator network and bound for an IMS client in a second operator network, in the case the second operator network includes a WV network;

FIG. 4 is a message sequence diagram showing routing according to the invention for a message originating from a WV client in a first operator network and bound for an IMS client in a second operator network, in the case the second operator network does not include a WV network; and

FIG. 5 is a block diagram showing elements participating in routing, according to the invention, messages between an IMS client in a first operator network and a WV client in a second operator network.

### BEST MODE FOR CARRYING OUT THE INVENTION

The invention is described below as providing inter operability between an IMS client and a WV client in another domain (network). It should be understood, however, that the invention encompasses not only IMS/WV interoperability, but interoperability between any SIP system and a WV system, as explained below.

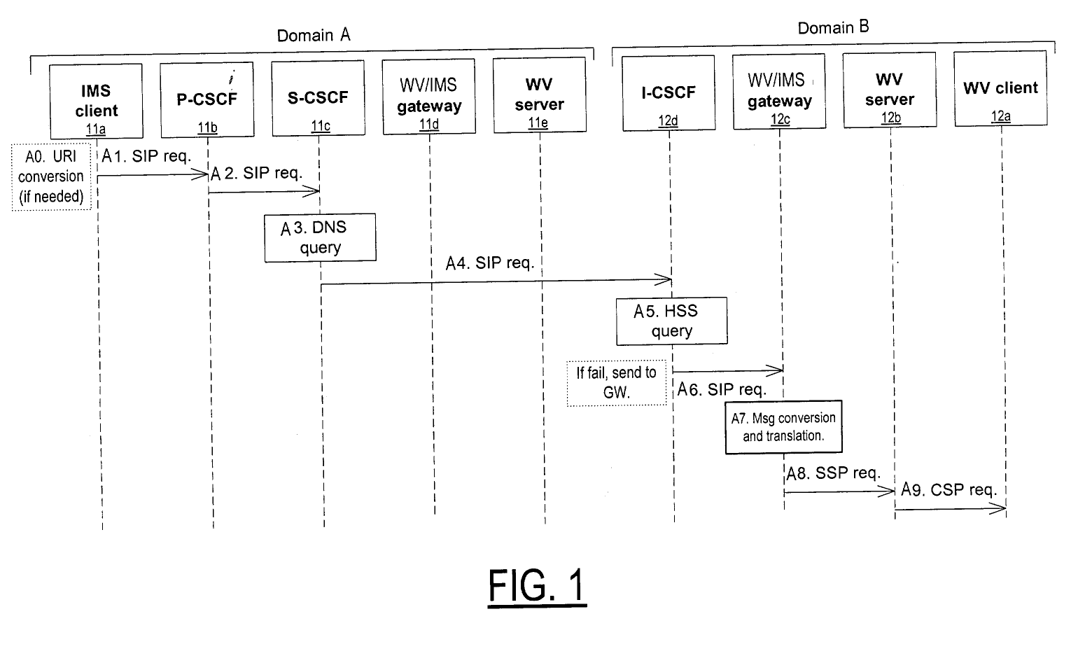

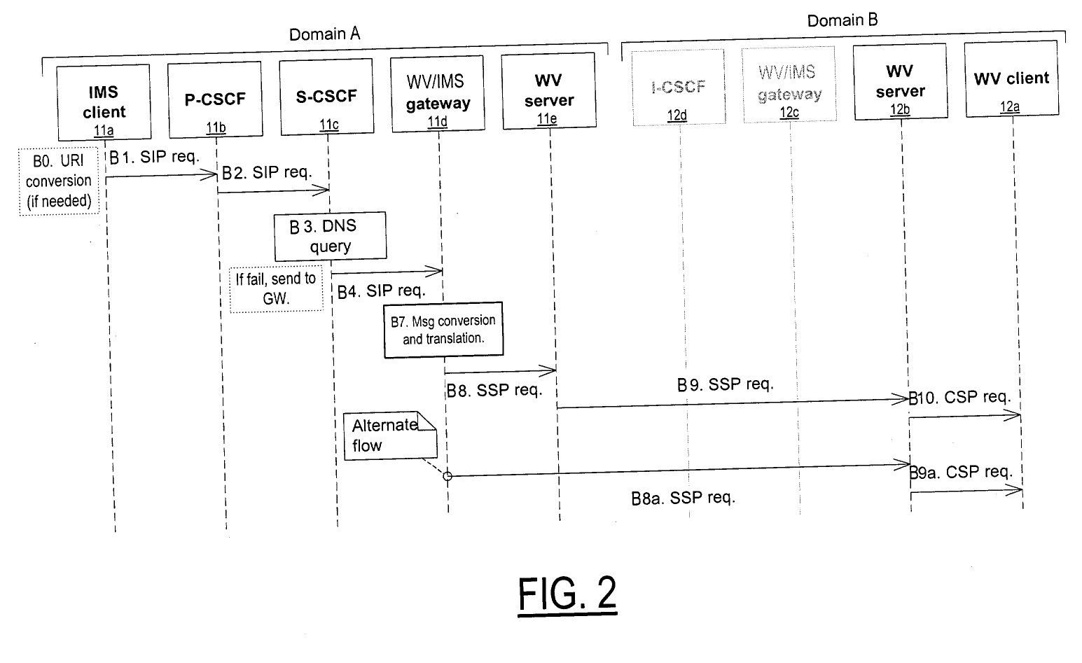

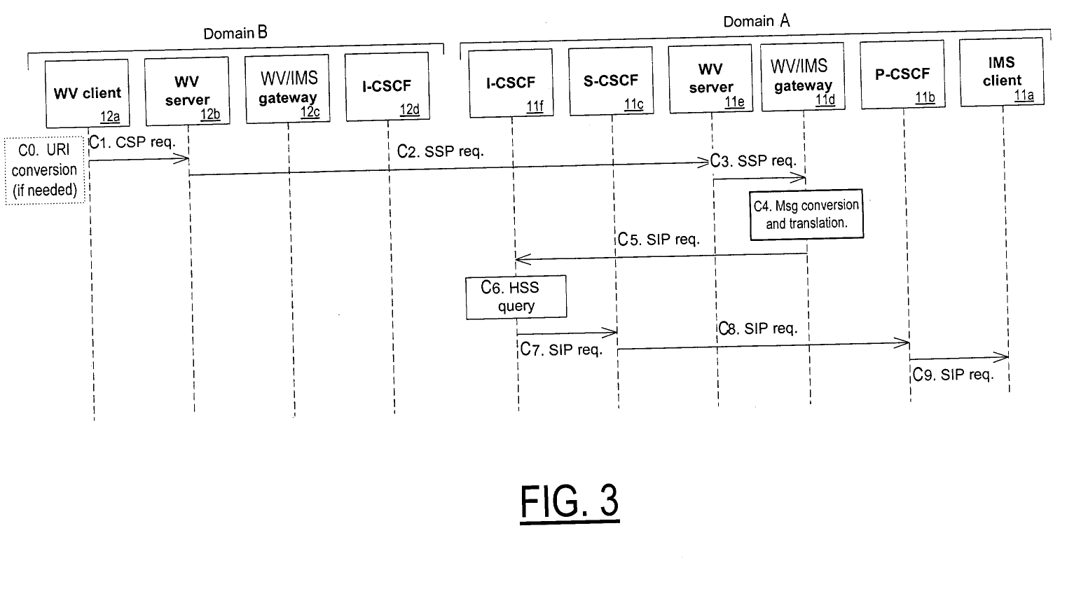

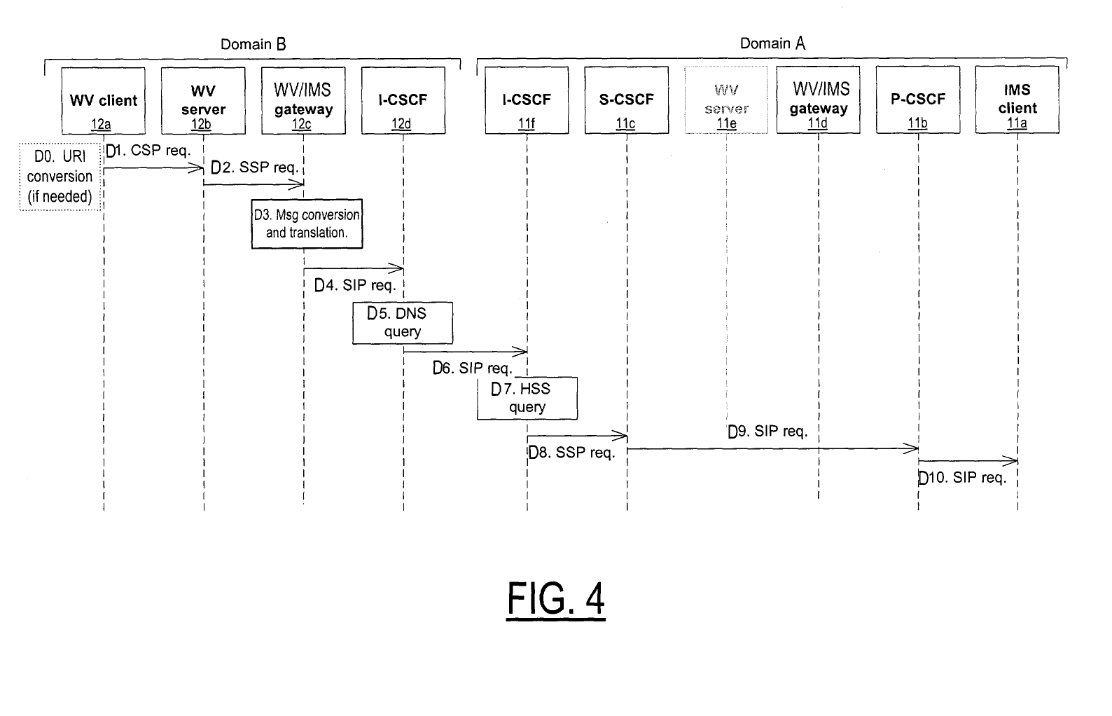

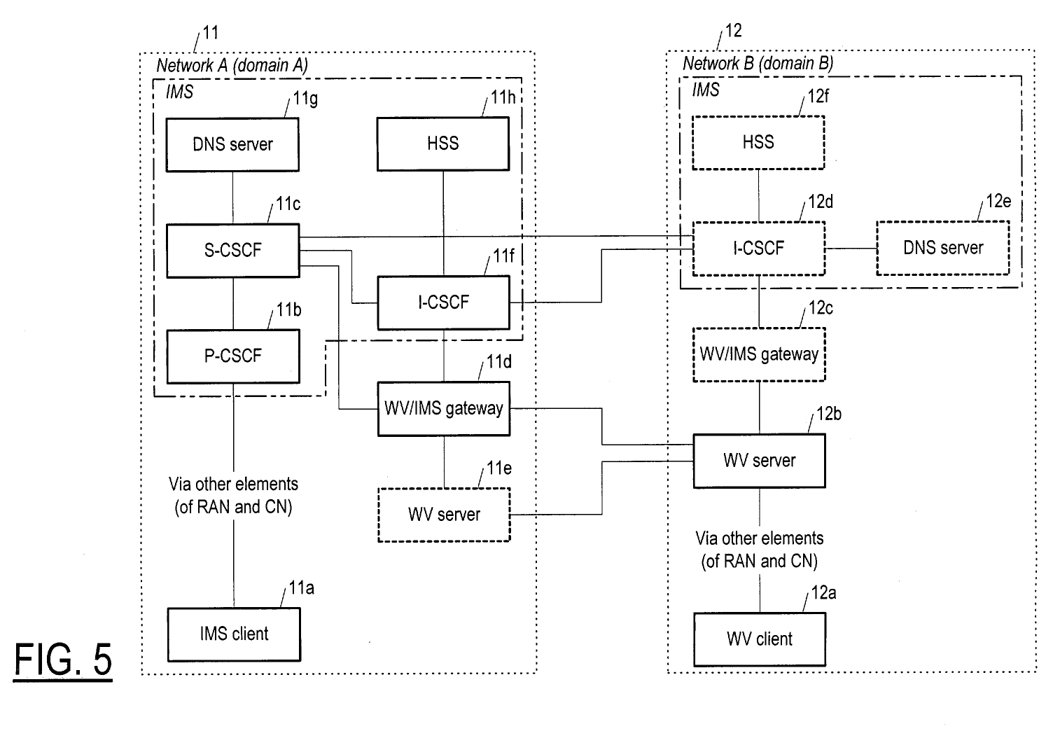

Referring to FIG. 5, the invention provides for communicating messages between an IMS client 11a of a network A 11 and a WV client 12a of a network B, possibly different than network A. The invention is illustrated in FIGS. 1 and 2 for communicating a message from IMS client 11a to WV client 12a, and in FIGS. 3 and 4 for communicating a message from WV client 12a to IMS client 11a. FIGS. 1-4 show steps of the process of routing a message between the IMS client 11a and WV client 12a, but do not show all such steps. In particular, no steps are shown taken by the respective radio access network and core network elements connecting the IMS client 11a and WV client 12a to their respective telecommunication systems. (FIG. 5 does not illustrate the relevant entities in case of roaming, since whether or not either the IMS client 11a or the WV client 12a is roaming is irrelevant to an explanation of the invention; the invention encompasses roaming without change from cases in which neither the IMS client 11a nor the WV client 12a is roaming.)

Referring now to FIG. 1, a message sequence diagram is shown for a scenario in which domain B 12 includes an IMS and a message originates with the IMS client 11a intended for the WV client 12a having a URI of e.g. wv:wv-user@domain-b. The URI used in the message is assumed here to have been converted (in a step A0) by either the IMS client 11a itself, or by the P-CSCF 11b (or possibly the S-CSCF 11c) so as to include the SIP scheme “sip:” instead of “wv:” and so the message at the S-CSCF 11c is assumed here to have a URI of e.g. sip:wv-user@domain-b, and is in all respects a message according to SIP as set forth by 3GPP. (It might be that the end user never types a scheme, and instead the terminal forces the scheme, i.e. the terminal always inserts ‘sip:’ as the default scheme in the URI.) In steps A1 and A2 the message to be communicated to WV client 12a is sent from IMS client 11a to S-CSCF 11c; (steps A1 and A2 may be before or after the URI conversion). S-CSCF 11c queries DNS server 11g (in step A3) for an IP address for a next hop element in the domain indicated in the URI of the message, (e.g. domain-b). Typically, the DNS query provides the IP address of the target side I-CSCF (or SIP proxy stored as entry point to that domain in a DNS entry), which is I-CSCF 12d of domain B in this scenario, and it is assumed here that such an IP address is provided by the DNS server 11g; S-CSCF 11c then forwards the message to I-CSCF 12d (in step A4). I-CSCF 12d of domain B then queries HSS 12f (or the directory or databases service used for lookup in the local domain) for the location of the S-CSCF assigned to the user with username wv-user, and determines that the username does not correspond to any IMS user and so is not an IMS client and therefore might be a WV client in domain B. I-CSCF 12d therefore forwards the message to the target-side WV/IMS gateway 12c. Upon receiving the message, the WV/IMS gateway 12c does two things: first it converts the URI to a WV URI, i.e.e.g. wv:wv-user@domain-b, and then it translates the message to a WV SSP protocol. Finally, in steps A8 and A9 the message is sent from the WV/IMS gateway to WV server 12b and (eventually) to WV client 12a. (If WV client is found out not to be a subscriber, an error is returned.) To account for the possibility that the target address corresponds to an IMS user without subscribed IMS services but which has registered with IMS and so has an assigned/serving S-CSCF with an address stored in the HSS of the target domain, the target-side I-CSCF 12d can fork the message to (send the message simultaneously to) both the assigned/serving S-CSCF (having gotten its address from HSS) and to the WV/IMS gateway 12c. Alternatively, the I-CSCF can send the message sequentially to first either the S-CSCF or to the WV/IMS gateway 12c, and then to the other if the first fails.

Referring now to FIG. 2, a message sequence diagram is shown for a scenario in which domain B 12 does not include an IMS and a message again originates with the IMS client 11a intended for the WV client 12a having a URI of e.g. wv:wv-user@domain-b. As in the scenario illustrated in FIG. 1, the URI used in the message is again assumed here to have been converted (in a step B0) by either the IMS client 11a itself, or by the P-CSCF 11b (or possibly the S-CSCF 11c) so as to include the SIP scheme “sip:” instead of “wv:” and so the message at the S-CSCF 11c is assumed here to have a URI of e.g. sip:wv-user@domain-b, and is in all respects a message according to SIP as set forth by 3GPP. In a step B1, the IMS client 11a sends the message to the P-CSCF 11b, which forwards it to the assigned (serving) S-CSCF 11c. In a next step B3, the S-CSCF 11c makes a DNS query to obtain the next hop address, expecting an address of an I-CSCF in the target domain. The DNS query fails since domain B in this scenario domain B does not include an IMS network, and so in a next step B4 the S-CSCF 11c forwards the message (possibly using an additional location service mechanism to locate the address of the next hop sever or gateway) to the local domain IMS/WV gateway 11d, which in a next step B7 (so labeled to correspond to the steps indicated in FIG. 1) performs the URI conversion and protocol translation. There are two alternative routes (flows) for the message leaving the originating side (local) WV/IMS gateway 11d: in one route, in a next step B8 the message is routed to a local (originating side) WV server 11e, and then in a next step B9 to the home (target-side) WV server 12b and then in a final step B10 to the WV client 12a; in the other, alternative route, in a next step B8a, the message is routed directly to the home WV server 12b and then in a final step B9a, on to the WV client 12a. If the WV/IMS gateway 11d is integrated with the WV server 11e, then the message is routed through the WV server 11f and from there it goes to the WV server 12b in the target domain based on WV routing via SSP.

Referring now to FIG. 3, a message sequence diagram is shown for a scenario in which domain A 11 includes a WV server 11e, and a message originates with the WV client 12a intended for the IMS client 11a having a URI of e.g. sip:ims-user@domain-a. The URI used in the message is assumed here to have been converted (in a step C0) by either the WV client 12a itself, or by the home WV server 12a so as to include the WV scheme “wv:” instead of “sip:” and so the message at the WV server 12b is assumed here to have a URI of e.g. wv:ims-user@domain-a, and is in all respects a message according to SSP. (It might be that the end user never types a scheme, and instead the terminal (WV client) 12a forces the scheme, i.e. the terminal 12a always inserts ‘wv:’ as the scheme in the URI.) In step C1 the message is sent from WV client 12a to the home WV server 12b as a CSP message; (step C1 may be before or after the URI conversion). In step C2, after searching a local database for a WV server in the target domain (all operators keep as part of WV a database of the addresses of WV servers from other domains) and finding the target domain WV server 11e, the local WV server 12b forwards the message to the target domain WV server 11e as an SSP message. In step C3, after determining that the target is not a WV client (based on a local database), the target domain WV server 11e forwards the message (as an SSP message) to the target domain WV/IMS gateway 11d. In step C4, the WV/IMS gateway 11d changes the address scheme from ‘wv:’ to ‘sip:’ and also translates the message from SSP to SIP, and then in step CS forwards the message to the local IMS network, i.e. to I-CSCF 11f, which then routes the message as usual according to IMS procedure (so that in steps C6 through C8, the message is routed ultimately to the target IMS client 11a, via its assigned/serving S-CSCF 11c and its P-CSCF 11b).

Referring now to FIG. 4, a message sequence diagram is shown for a scenario in which a message again originates with the WV client 12a intended for the IMS client 11a having a URI of e.g. sip:ims-user@domain-a but domain A 11 does not include a WV server. The URI used in the message is again assumed to have been converted (in a step D0) by either the WV client 12a itself, or by the home WV server 12a so as to include the WV scheme “wv:” instead of “sip:” and so the message at the WV server 12b is assumed here to have a URI of e.g. wv:ims-user@domain-a, and is in all respects a message according to SSP. (As in the scenario illustrated in FIG. 3, it might be that the end user never types a scheme, and instead the terminal (WV client) 12a forces the scheme, i.e. the terminal 12a always inserts ‘wv:’ as the scheme in the URI.) In step D1 the message is sent from WV client 12a to the home WV server 12b as a CSP message; (step D1 may be before or after the URI conversion). In step D2, after searching (a local database) for a WV server in the target domain but not finding one, the home WV server 12b forwards the message as an SSP message to the originating domain WV/IMS gateway 12c; as an alternative flow, in case the WV server 12b knows the address of the WV/IMS gateway 11d of the target domain, it can send the request directly there. In step D3, the WV/IMS gateway 12c changes the address scheme from ‘wv:’ to ‘sip:’ and also translates the message from SSP to SIP, and then in step D4 forwards the message to the local IMS network, i.e. to I-CSCF 12d of domain B, which then routes the message as usual according to IMS procedure (so that in steps D5 through D10, the message is routed ultimately to the target IMS client 11a, via the target domain I-CSCF 11c, its assigned/serving S-CSCF 11c, and its P-CSCF 11b).

As mentioned above, it is important to understand that the invention is not restricted to aspects of interoperability between IMS and WV, but rather to interoperability between a WV network in one domain and any session/transaction control protocol based network, such as an SIP based network, in another domain, with the session/transaction control protocol based network having entities with roles analogous to the X-CSCF entities (i.e. the P-CSCF, S-CSCF and I-CSCF entities) of IMS. In the context of the present invention, IMS is to be understood as but one example of an SIP based network, which is in turn but one example of a session/transaction control protocol based network having entities with roles analogous to the X-CSCF entities, even if those entities are bundled differently than in IMS or identified by very different names.

The description in terms of an IMS client and the corresponding IMS routing is merely illustrative of the invention. The IMS network routes messages using X-CSCF entities that are basically SIP proxies or registrars. All the functionality assigned to the X-CSCF entities of IMS according to the above description can also be assigned to corresponding SIP proxies or registrars in any other kind of SIP based network, and in fact in some other SIP based networks to which the invention applies (in particular, some on the Internet but not part of IMS) there are call state control function entities similar to those in IMS and even named in the same way (although, as explained, the names of the entities and how the entities are bundled is irrelevant to the scope of the invention). In some such networks, P-CSCF is an outbound proxy, S-CSCF is a home proxy, and I-CSCF is an inbound proxy; the routing is thus from a terminal, to the outbound proxy (P-CSCF), to the inbound proxy (I-CSCF), to the home proxy (S-CSCF), and finally to the target terminal.

For simplicity in pointing out the invention, we use the phraseology “SIP type of network” to indicate any SIP type of network, meaning any session/transaction control protocol based network (of which an SIP based network, such as IMS, is but an example) having entities with roles analogous to the X-CSCF entities of IMS. Thus, it should be understood that the invention applies in the case of any SIP type of network in a first domain and having entities with roles analogous to the X-CSCF entities of IMS (and where the first domain may also include elements of a WV network) interoperating with a WV network in a second domain (which may also include elements of the SIP type of network), and the terminology X-CSCF (i.e. P-CSCF, S-CSCF, and I-CSCF) is used here to indicate entities with roles generally analogous to the so-named entities in IMS.

The invention provides not only a method by which various elements of a first (operator) communications network 11 and a second (operator) communication network 12 cooperate and route messages so as to provide interoperability between a client of an SIP type of network in the first network 11 and a client of a WV network in the second network 12, but also equipment of the two networks 11 12 operative according to the method, and also computer instructions implementing the method and according to which the equipment is operative.

It is to be understood also that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

What is claimed is:

1. A method by which a first device (11a), operable in a first network (11) including an SIP type of network to which the first device (11a) is subscribed, communicates with a second device (12a), operable in a second network (12) including a wireless village (WV) network to which the second device (12a) is subscribed, the SIP type of network having a serving call state control function (S-CSCF) entity (11c) for communicating with the first device (11a) via a proxy CSCF (P-CSCF) entity (11b) using a first protocol (SIP) requiring that a message have a request uniform resource identifier (URI) including an address scheme (“sip:”) according to the first protocol (SIP), the WV network having a WV server (12b) for communicating with other WV servers using a second protocol (SSP) and with the second device (12a) using a third protocol (CSP; CLP) possibly different from the second protocol (SSP), the method characterized in case of a message originating with the first device (11a) and intended for the second device (12a) by:
a step (A4 B4) in which the S-CSCF (11c) of the first network routes the message to either a gateway (11d) in the first network (11) upon a determination that the second network does not include an SIP type of network, or to an interrogating CSCF (I-CSCF) (12d) of an SIP type of network in the second network (12) which then in a subsequent step (A6) routes the message to a gateway (12c) in the second network (12) upon a determination by the I-CSCF (12d) of the second network (12) that the URI does not correspond to a subscriber to the SIP type of network in the second network (12);
and further characterized in the case of a message originating with the second device (12a) and intended for the first device (11a) by:
a step (C2 D2) in which the WV server (12b) of the second network (12) routes the message either to a gateway (12c) in the second network (12) or to a gateway (11d) in the first network (11) or to a WV server (11e) in the first network.

2. A method as in claim 1, the method further characterized in case of a message originating with the first device (11a) and intended for the second device (12a) by: a step (A0 B0) in which if the message is entered into the device (11a) operable in the first network with a URI having an address scheme according to other than the first protocol (SIP), before the S-CSCF (11c) of the first network (11) performs a domain name space (DNS) query for routing the message, the URI of the message is converted by either the first device (11a) or the P-CSCF (11b) or the S-CSCF (11c) to use the address scheme (“sip:”) according to the first protocol (SIP).

3. A method as in claim 1, the method further characterized in the case of a message originating with the second device (12a) and intended for the first device (11a) by: a step (C0 D0) in which if the message is entered into the second device (12a) with a URI having an address scheme according to other than the second protocol (SSP), either the second device (12a) or the WV server (12b) converts the URI to use the address scheme (“wv:”) according to the second protocol (SSP).

4. A method as in claim 1, wherein the P-CSCF (11b) and S-CSCF (11c) of the first network are elements of an Internet Protocol Multimedia Subsystem (IMS).

5. A method as in claim 1, wherein the I-CSCF (12d) of the second network is an element of an Internet Protocol Multimedia Subsystem (IMS).

6. A method as in claim 1, further characterized in case of the message originating with the first device (11a) by: a step (A7 B7) in which either the gateway (11d) in the first network (11) or the gateway (12c) in the second network converts the URI so as to use the address scheme according to the second protocol (SSP) and also translates the message so as to be in accord with the second protocol (SSP).

7. A method as in claims 1, further characterized in case of the message originating with the second device (12a) by: a step (C4 D3) in which either the gateway (12c) in the second network (12) or the gateway (11d) in the first network (11) converts the URI so as to use a scheme (“sip:”) according to the first protocol (SIP) and also translates the message so as to be in accord with the first protocol (SIP).

8. An apparatus (11a), comprising means for performing the steps of claim 2 indicated as the steps performed by the first device (11a).

9. An apparatus (12a), comprising means for performing the steps of claim 3 indicated as the steps performed by the second device (12a).

10. A system, comprising means for performing the steps of claim 2 indicated as the steps performed by the P-CSCF (11b), the S-CSCF (11c) and the gateway (11d) of the first network (11).

11. A system, comprising means for performing the steps of claim 2 indicated as the steps performed by the P-CSCF (11b), the S-CSCF (11c) of the first network (11), and the WV server (11e) of the first network (11).

12. A system, comprising means for performing the steps of claim 1 indicated as the steps performed by the WV server (12b) and the gateway (12c) of the second network (12).

13. A system, comprising means for performing the steps of claim 1 indicated as the steps performed by the WV server (12b) and the gateway (12c) of the second network (12), and indicated as the step of receiving the message performed by the I-CSCF (12d) of the second network (12).

14. A storage medium holding a set of instructions for execution by a processor included in an apparatus (11a), the set of instructions comprising instructions for performing the steps of claim 2 indicated as the steps performed by the first device (11a).

15. A storage medium holding a set of instructions for execution by a processor included in an apparatus (12a), the set of instructions comprising instructions for performing the steps of claim 3 indicated as the steps performed by the second device (12a).

16. One or more storage media holding sets of instructions for execution by processors included in equipment (11b-d) of a communication network, the sets of instructions comprising instructions for performing the steps of claim 2 indicated as the steps performed by the P-CSCF (11b), the S-CSCF (11c) and the gateway (11d) of the first network (11).

17. One or more storage media holding sets of instructions for execution by processors included in equipment (11b-d) of a communication network, the sets of instructions comprising instructions for performing the steps of claim 2 indicated as the steps performed by the P-CSCF (11b) and the S-CSCF (11c) of the first network (11) and also the step of receiving the message performed by the WV server (11e) of the first network.

18. One or more storage media storing sets of instructions for execution by processors included in equipment (12b-c) of a communication network, the sets of instructions comprising instructions for performing the steps of claim 1 indicated as the steps performed by the WV server (12b) and the gateway (12c) of the second network (12).

19. One or more storage media storing sets of instructions for execution by processors included in equipment (12b-d) of a communication network, the sets of instructions comprising instructions for performing the steps of claim 1 indicated as the steps performed by the WV server (12b) and the gateway (12c) of the second network (12), and also the step of receiving the message performed by the I-CSCF (12d) of the second network (12).
